(19) United States
(12) Patent Application Publication
(10) Pub. No.: US 2015/0001288 A1
(43) Pub. Date: Jan. 1, 2015

(54) METHOD AND A SYSTEM FOR MEASURING MAIL CARRYING TIMES

(71) Applicant: Solystic, Bagneux (FR)

(72) Inventors: Eric BUISSONNET, Ivry Sur Seine (FR); Christophe CAILLON, Bretigny Sur Orge (FR)

(21) Appl. No.: 14/310,745

(22) Filed: Jun. 20, 2014

(30) Foreign Application Priority Data
Jun. 26, 2013 (FR) 1356130

(51) Int. Cl. G06Q 10/08

(52) U.S. Cl. CPC G06Q 10/083
USPC 235/376

(57) ABSTRACT

A method of measuring the times taken for carrying mail through a network of postal sorting machines between at least a mail departure point and a mail arrival point, which method comprises the following steps, a) using first dummy mailpieces to measure first mail carrying times taken to carry said first dummy mailpieces from the departure point to a certain postal sorting machine of the network; b) using real mailpieces to measure second mail carrying times taken to carry said real mailpieces from said certain sorting machine of the network to another postal sorting machine of the network; and c) using second dummy mailpieces to measure third mail carrying times taken to carry said second dummy mailpieces from said other postal sorting machine to the arrival point.

### CROSS-REFERENCE TO RELATED APPLICATIONS

This application claims benefit of French patent application number 1356130, filed Jun. 26, 2013, which is herein incorporated by reference.

### BACKGROUND OF THE INVENTION

1. Field of the Invention

The invention relates to measuring quality of service between postal authorities, such quality of service being involved in particular in computing financial clearing between such authorities. More particularly, the invention relates to evaluating the logistics performance of the postal authorities, in particular for international mail sent as a “Priority” service, namely evaluating times taken for carrying such mail that goes via postal sorting machines from a departure point situated in one country to an arrival point situated in another country.

2. Description of the Related Art

Conventionally, postal authorities measure the times taken for carrying mail in statistical manner, using dummy mailpieces or test mailpieces that are inserted into the flow of mail from predetermined insertion points, that are, for example, mail departure post offices of a national postal authority. Such test mailpieces go via sorting machines of said national postal authority together with the normal mail, going via sorting and international exchange centers, so as to arrive in another country where they also go via postal sorting machines of another national postal authority before they arrive at predetermined delivery points, e.g. mail arrival offices of said other national postal authority.

U.S. Pat. No. 8,346,675 discloses a method and apparatus for measuring the performance a postal service by using dummy mailpieces or “tag mailpieces”, each of which is provided with a Radiofrequency Identification (RFID) tag.

The date and time at which those test mailpieces are inserted at the insertion points and the date and time of arrival of the same test mailpieces at the delivery points are read and stored in a database so as to be analyzed to determine the journey times taken for carrying the mail over the various possible mail carrying routes.

US Publication No. 2007/0250211 also discloses a method of measuring the performance of a postal service by using dummy mailpieces and a network of sensors distributed over the logistics network of the postal service so as to feed back the dates and times of passing of the test mailpieces to an analysis system.

Such measurement systems are becoming increasingly costly to implement, in particular for measuring the times taken for carrying international mail because the number of mail carrying paths over which measurement needs to be performed is increasing due to the number of possible combinations between all of the mail insertion points and all of the mail delivery points.

In addition, for the measurement to be reliable, it is necessary to make the dummy mailpieces indistinguishable from the real mailpieces so that they go imperceptibly past the operators on sorting machines or the like, which is costly.

More particularly, in order to measure quality of service on international mail, it can be necessary to use more than 300,000 test mailpieces per year, while also limiting the measurement to one test mailpiece per day and per mail carrying route. It is clear that the higher the number of postal authorities working together for providing an international postal service, the higher the number of mail carrying routes becomes, and the higher the number of test mailpieces that are necessary for measuring the quality of service.

### SUMMARY OF THE INVENTION

An object of the invention is to provide a solution for improving the quality of the measurement of performance while also reducing the cost of implementing it.

The basic idea of the invention stems from the observation that, at sorting and international exchange centers, mail carrying routes converge and then diverge, and that, over the path traveled by the mail between the exchange centers, it can be advantageous to measure performance by using real mailpieces rather than by using dummy mailpieces.

More particularly, the invention provides a method of measuring the times taken for carrying mail through a network of postal sorting machines between at least a mail departure point and a mail arrival point, which method comprises the following steps:

a) using first dummy mailpieces to measure first mail carrying times taken to carry said first dummy mailpieces from the departure point to a certain postal sorting machine of the network that constitutes a point of convergence of the mail carrying routes in the network;

b) using real mailpieces to measure second mail carrying times taken to carry said real mailpieces from said certain sorting machine of the network to another postal sorting machine of the network that constitutes a point of divergence of the mail carrying routes in the network;

c) using second dummy mailpieces to measure third mail carrying times taken to carry said second dummy mailpieces from said other postal sorting machine to the arrival point; and

d) computing the total time taken to carry mail between said departure point and said arrival point on the basis of said first, second, and third mail carrying times.

The method of the invention may have the following features:

a digital image is formed of each real mailpiece, which image includes postal address information, and a unique identifier for said real mailpiece is derived from said digital image, thereby making it possible to track the real mailpiece without affecting its structural integrity;

each of said first and second dummy mailpieces bears a machine-readable unique identifier, e.g. a bar code or identifier recorded in the chip of an RFID tag, thereby enabling them to be tracked in contactless manner; and

the second mail carrying times are measured on a sample of real mailpieces, thereby enabling the measurement to be rendered more reliable.

The invention also provides a system for measuring the times taken for carrying mail through a network of postal sorting machines, said system wherein it comprises:

dummy mailpieces, each of which has a machine-readable identification code;

first pass sensors arranged to detect passing of a dummy mailpiece and to supply the identification code of the dummy mailpiece in association with time tracking data;

second pass sensors arranged to detect passing of a mailpiece, to form a digital image of said mailpiece, which image includes postal address information, and to supply, for said mailpiece, a unique digital mailpiece identifier in association with time tracking data, said unique identifier being derived from the digital image of said mailpiece; and

electronic equipment for maintaining a database that stores said dummy mailpiece identification codes and said digital identifiers in association with time tracking data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a very diagrammatic view of a postal network with postal sorting machines;

FIG. 2 shows a test mailpiece with an RFID tag;

FIG. 3 shows electronic time tracking equipment for tracking over time; and

FIG. 4 shows the database of the time tracking equipment for tracking mail over time in order to measure the performance of a postal network.

### DETAILED DESCRIPTION

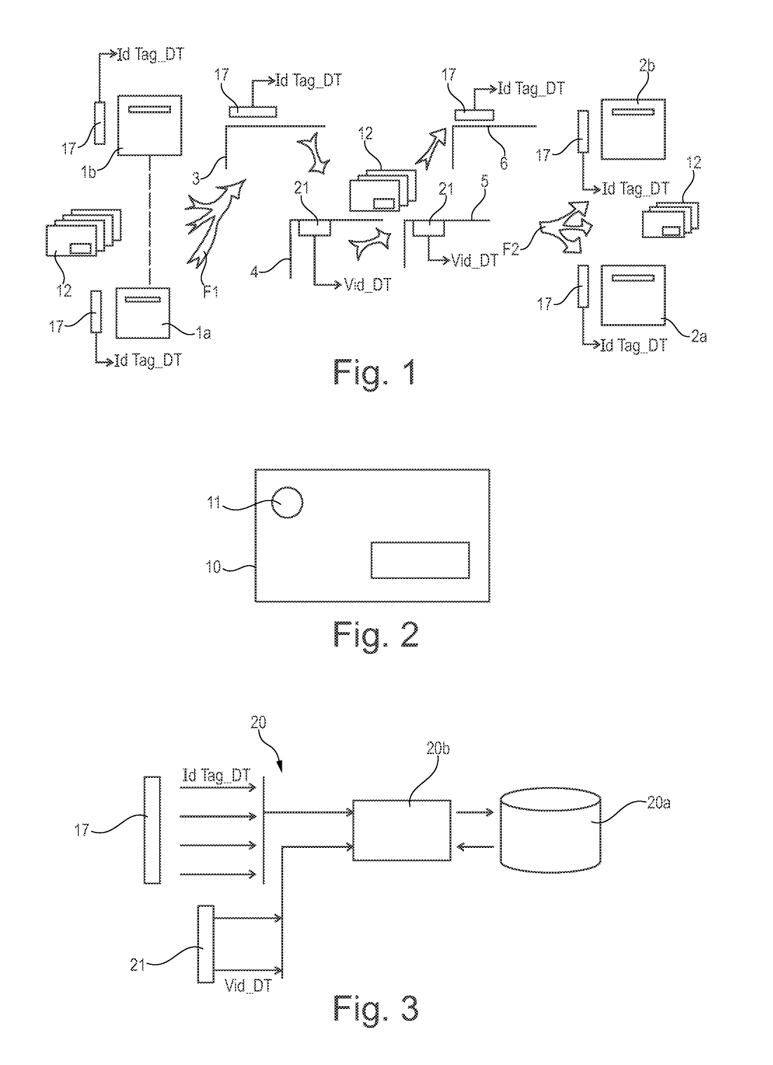

FIG. 1 is a very diagrammatic view of the architecture of a logistics network that is given by way of example and that serves for inward and outward sorting of international mail, in particular, in this example, with only two national postal authorities.

In this example, the network comprises first post offices 1a, 1b of a first postal authority, and second post offices 2a, 2b of a second postal authority. For simplification reasons, as regards measuring quality of service for international mail, it is considered that the first post offices 1a, 1b are departure post offices from which the international mail departs and that the second post offices are arrival post offices at which the international mail arrives.

In a variant, the departure point may be constituted by the sender handing over the test mailpiece to the post office or putting it in a mailbox, and the arrival point may be constituted by the test mailpiece being received by the recipient at the place of residence or the place of work of the recipient.

Naturally, the first postal authority may have a very large number of post offices such as 1a, 1b and the second postal authority may also have a very large number of post offices such as 2a, 2b.

The invention serves to measure the time taken for carrying mail, and more particularly international mail sent as a “Priority” service, between the departure post offices and the arrival post offices over the various routes for carrying the mail.

FIG. 1 also shows sorting machines such as 3 and 4 in the mail departure country, which sorting machines form parts of sorting centers of the first postal authority, the sorting machine 4 being the furthest downstream in the mail sorting in the departure country and, in known manner, forming part of a sorting and international exchange center of the departure country.

Sorting machines such as 5 and 6 are also shown in the mail arrival country, which sorting machines form parts of sorting centers of the second postal authority, the sorting machine 5 being the furthest upstream in the mail sorting in the arrival country and also forming part of an sorting and international exchange center of the arrival country.

Naturally, in each postal authority, the mail may be sorted in a plurality of sorting passes on different sorting machines, and it is thus possible to have a large number of sorting machines such as 3, 4, 5, and 6, in cascade or in parallel.

The method of the invention for measuring the times taken for carrying mail over a route for carrying the mail through the network, e.g. the route defined between the departure post office 1a and the arrival post office 2a, through the network of sorting machines 3, 4, 5, 6 is based on the mail carrying route being subdivided into three adjacent segments P1, P2, and P3.

In this example, segment P1 goes from the mail departure point, which is post office 1a in this example, to a sorting machine, e.g. a sorting machine of the sorting and exchange centre of the departure post office, this machine being sorting machine 4 in this example.

The segment P2 goes from a sorting machine of departure postal authority, and more specifically from a sorting machine of the sorting and international exchange center, which machine is sorting machine 4 in this example, to another sorting machine of the arrival postal authority, and more specifically a sorting machine of the sorting and international exchange centre of the arrival postal authority, which machine is sorting machine 5 in this example. It should be noted that, at this place in the network, the mail carrying routes converge and then diverge as indicated by the arrows F1 and F2 (and vice versa in the other direction of the mail carrying routes).

Segment P3 goes from a sorting machine of the arrival postal authority, e.g. a sorting machine of the sorting and international exchange center of the arrival postal authority, which machine is sorting machine 5 in this example, to the mail arrival point, which is post office 2a in this example.

In accordance with the invention, the times taken for carrying the mail over the segments P1 and P3 are measured using dummy mailpieces, referenced 10 in FIG. 2, i.e. test mailpieces or imitation mailpieces. These test mailpieces are designed to be mailpieces that are indistinguishable from the flow of normal mail. Each test mailpiece 10 bears a machine-readable unique identifier, e.g. a bar code or an identifier recorded in the chip of an RFID tag 11 placed inside the envelope of the test mailpiece 10.

In order to detect passage of this type of RFID-tagged test mailpiece, it is possible to use RFID sensors that are placed on detector gates or indeed in the sorting machines. The RFID sensors placed on detector gates make it possible to detect passage of the test mailpieces as they enter or exit post offices.

In accordance with the invention, times taken for carriage over the segment P2 of a route are measured using real mail indicated by 12 in FIG. 1, and, in particular, by using a technique of identifying each real mailpiece without any printing, preferably by deriving a unique identifier for a mailpiece on the basis of a digital image of it, which image includes postal address information that can be recognized automatically. Such performance measurement over segment P2 may thus be performed continuously over a large number of samples, thereby contributing to obtaining good measurement reliability. Since it is implemented mainly by software, it has little impact on the structure of the sorting machines or on the sorting method, and does not affect the structural integrity of the real mailpieces.

By subdividing the mail carrying routes into three segments in this way, it is possible to reduce the number of test mailpieces necessary for measuring performance over the segments P1 and P3.

Clearly the test mailpieces 10 used for measuring the times taken for carrying mail over a segment P1 may be used for measuring the times over a segment P3 of a mail carrying route.

The system of the invention for measuring the times taken for carrying mail comprises preferably contactless first pass sensors 17, which, in this example, are RFID sensors placed on detector gates respectively in the departure post office, i.e. in post office 1a in this example, and in the arrival post office, i.e. in post office 2a in this example, or indeed in the sorting machines of the sorting centers (e.g. downstream from the unstackers) on the sorting conveyor of the machine, said sensors 17 being suitable for detecting and reading the identification code IdTag of a test mailpiece and for associating it with time data DT including the date and time of the detection. Other information may also be associated with the date, such as a machine number or a reference giving the location of the reading. Naturally, these sensors 17 must be compatible with the speed of movement of the test mailpieces in the flow of real mail going via the conveyors of the postal sorting machines.

The time tracking data DT, in association with the identification codes IdTag, is sent via a communications network such as the Internet to remote electronic time tracking equipment 20 shown in FIG. 3 and comprising a database 20a accessible by a data processing unit 20b.

The information supplied by the sensors can be supplemented by the senders and by the recipients of the test mailpieces at the time of sending and of receiving of the test mailpieces, e.g. by logging onto the remote electronic time tracking equipment 20 via an Internet connection.

In addition, at the sorting machines 4 and 5 at the two ends of a segment P2, the measurement system comprises second pass sensors 21 arranged to detect passing of a real mailpiece such as 12, and to form (or to retrieve) a digital image of said real mailpiece, which image includes recipient postal address information (that has been machine-recognized automatically), and to supply, for said mailpiece, a unique digital mailpiece identifier Vid derived from said digital image in association with time tracking data DT including a detection date and time. Said unique identifier Vid may, for example, be computed as described in Patent Document FR 2 841 673, and may comprise two independent components, one derived from the pixels of the image, and the other derived from the automatically recognized recipient address.

The sensors 21 transmit the identifiers Vid in association with the time tracking data DT to the equipment 20 via an electronic communications network in the same way as for the sensors 17.

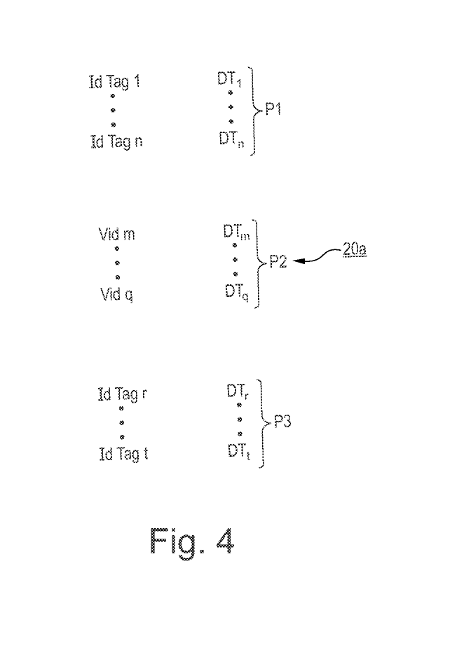

As shown by FIG. 4, in the database 20a, and for each examined mail carrying route, the unit 20b archives, as and when they arrive, identification codes Id-Tag1 . . . 1d-Tagn, IdTagr . . . IdTagt in association with respective time tracking data DT1 . . . DTn, DTr . . . DTt for the segments P1 and P3 of the route, and identifiers Vidm . . . Vidq in association with time tracking data DTm . . . DTq for the segment P2 of the route. Naturally, there is no need for synchronization between the measurements over the segments P1, P2, and P3.

On the basis of the time tracking data archived in the database 20b for each segment P1, P2 and P3 of a route, the unit 20b is capable of determining statistics on the total carrying time over said route, as indicated below.

In practice, images of these real mailpieces are recorded, for example, by the sorting machine 4 in compressed form in a file. The file is transferred and then stored in a sorting machine 5 for detecting the mailpieces of the sample. Naturally, without going beyond the ambit of the invention, the images file may also be stored on one or more remote data servers that are connected to said sorting machines 4 and 5.

It can be understood that, in order to be able to measure mail carrying times T taken for carrying mail over the route between the departure point 1a and the arrival point 2a, the unit 20b is suitable for:

searching the database 20a for two identical identification codes of a test mailpiece, e.g. IdTag1 and IdTagn, and by association of these codes, retrieving two pass dates at which the test mailpiece went past, these dates being DT1 and DTn in this example, and, by subtracting one of these pass dates from the other, computing a first journey time T1 taken for carrying the test mailpiece over the segment P1 (DTn−DT1);

searching the database 20a for two matching digital identifiers of a real mailpiece, e.g. Vidm and Vidq, and by association of the identifiers, retrieving two pass dates DTm and DTq at which the real mailpiece went past, and, once again by subtraction, computing a second journey time T2 taken for carrying the real mailpiece (DTq−DTm); and

searching the database 20a again for two identical identification codes of a test mailpiece, e.g. IdTagr and IdTagt, and by association of these codes, retrieving two pass dates at which the test mailpiece went past, these dates being DTr and DTt in this example, and, by subtracting one of these pass dates from the other, computing a third journey time T3 taken for carrying the test mailpiece over the segment P3 (DTt−DTr); and

finally, adding up the journey times T1, T2, and T3 for calculating statistical values for the total time taken for carrying the mail over the route between the points 1a and 2a.

The equipment 20 can operate with a series of successive test mailpieces over the same mail carrying route and with sampling on real mailpieces so as to produce statistical data giving minima, maxima, averages, etc. for the total journey time over the mail carrying route.

It can be understood that, in order to make the measurements more reliable, the sensors 17 may be placed as close as possible to the sensors 21 at the junction between segments P1 and P2 and at the junction between segments P2 and P3, e.g. in the same postal sorting machine.

Such a measurement system of the invention is well suited for giving accurate and reliable measurements of the times taken for carrying international mail sent as a “Priority” service using the International Post Corporation's “UNEX” study. However, the measurement method and system of the invention may also be used for other types of mail or for analogous articles.

While the foregoing is directed to embodiments of the present invention, other and further embodiments of the invention may be devised without departing from the basic scope thereof, and the scope thereof is determined by the claims that follow.

1. A method of measuring the times taken for carrying mail through a network of postal sorting machines between at least a mail departure point and a mail arrival point which method comprises the following steps:
a) using first dummy mailpieces to measure first mail carrying times taken to carry said first dummy mailpieces from the departure point to a certain postal sorting machine of the network that constitutes a point of convergence of the mail carrying routes in the network;
b) using real mailpieces to measure second mail carrying times taken to carry said real mailpieces from said certain sorting machine of the network to another postal sorting machine of the network that constitutes a point of divergence of the mail carrying routes in the network;
c) using second dummy mailpieces to measure third mail carrying times taken to carry said second dummy mailpieces from said other postal sorting machine to the arrival point; and
d) computing the total time taken to carry mail between said departure point and said arrival point on the basis of said first, second, and third mail carrying times.

2. A method according to claim 1, wherein a digital image is formed of each real mailpiece, which image includes postal address information, and a unique identifier for said real mailpiece is derived from said digital image.

3. A method according to claim 1, wherein each of said first and second dummy mailpieces bears a machine-readable unique identifier.

4. A method according to claim 3, wherein said machine-readable unique identifier is contained in the chip of an RFID tag.

5. A method according to claim 2, wherein the second mail carrying times are measured on a sample of real mailpieces.

6. A method according to claim 1, wherein said postal sorting machines are part of an international mail sorting and exchange center.

7. A system for measuring the times taken for carrying mail through a network of postal sorting machines, said system wherein it comprises:
dummy mailpieces, each of which has a machine-readable identification code;
first pass sensors arranged to detect passing of a dummy mailpiece and to supply the identification code of the dummy mailpiece in association with time tracking data;
second pass sensors arranged to detect passing of a mailpiece, to form a digital image of said mailpiece, which image includes postal address information, and to supply, for said mailpiece, a unique digital mailpiece identifier in association with time tracking data, said unique identifier being derived from the digital image of said mailpiece; and
electronic equipment for maintaining a database that stores said dummy mailpiece identification codes and said digital identifiers in association with time tracking data.

8. A system according to claim 7, wherein each dummy mailpiece includes an RFID tag, the chip of which stores a dummy mailpiece identification code.
